(19) United States
(12) Patent Application Publication
(10) Pub. No.: US 2025/0375990 A1
(43) Pub. Date: Dec. 11, 2025

(54) MULTIPURPOSE BOAT WITH AN ADAPTABLE DECK ASSEMBLY

(71) Applicant: RedHead Boats LLC, Eagle Mountain, UT (US)

(72) Inventor: Brandon King, Eagle Mountain, UT (US)

(73) Assignee: RedHead Boats LLC, Eagle Mountain, UT (US)

(21) Appl. No.: 19/230,049

(22) Filed: Jun. 5, 2025

Related U.S. Application Data
(60) Provisional application No. 63/656,499, filed on Jun. 5, 2024.
(60) Provisional application No. 63/656,476, filed on Jun. 5, 2024.

(51) Int. Cl. B60F 3/00; B62D 63/06; B63B 35/38; B63B 73/10

(52) U.S. Cl. CPC B60F 3/0069; B60F 3/0038; B60F 3/0092; B62D 63/06; B63B 35/38; B63B 73/10

(57) ABSTRACT

A watercraft having a frame which incorporates rails and a plurality of sleeve members. The rails may be used to increase modularity of the watercraft and increase the surface area for attachment of accessories and may be comprised of modular aluminum extrusion. The sleeve members may be used to attach a variety of accessories for recreational watercrafting or for fastening the watercraft to a trailer.

### CROSS-REFERENCE TO RELATED APPLICATIONS

This is a non-provisional application that claims priority to U.S. Provisional Patent Application No. 63/656,499 filed Jun. 5, 2024. The disclosure of that application is specifically incorporated by reference herein for all that it discloses and teaches.

### BACKGROUND OF THE INVENTION

### The Field of the Invention

Aspects of the present invention relate to a watercraft. More specifically, some embodiments of the invention relate to a modular catamaran boat designed for versatile use in various aquatic environments and adaptable modification of a boat's accessories and configured to share camping accessories between the watercraft and a trailer.

### Background

Watercraft are powered or unpowered vehicles used for transportation and navigation on bodies of water. Recreational watercrafts are used for many purposes, including fishing, boating, sight-seeing, canoeing, sailing, and similar activities.

In the field of recreational watercraft many people are inhibited from owning a recreational watercraft due to the entry cost and the substantial associated costs of trailering, towing, storage, and tax/licensing.

Recreational watercraft can be divided into two categories by transport method, toppable and trailerable. Toppables include canoes, kayaks, paddle boards and inflatables. Toppable watercraft can be transported on top of a car and stored on a wall or ceiling. Toppables generally require a degree of skill and limit participation to one or two people. However, toppables eliminate the costs of a trailer and larger tow vehicle.

Trailerable watercraft include all power boats that require trailering to the waterways. Trailerable watercraft generally accommodate the participation of multiple people in relative comfort, but require a dedicated boat trailer, year-round storage, taxes and licensing, and a larger tow vehicle

### SUMMARY

A solution to some of the above-mentioned problems is to have a boat that accommodates the participation of multiple people, while reducing or eliminating the costs of a dedicated boat trailer and a larger tow vehicle. A partner trailer designed to transport this boat solves the problem of a dedicated boat trailer by incorporating the same modular deck assembly within the trailer frame. Giving both the trailer and boat the ability to interchange camping, and comfort accessories.

The present disclosure describes a watercraft apparatus. Preferred embodiments include a watercraft with an adaptable watercraft-deck assembly, the watercraft being used for recreational and residential use and having size dimensions that allow the watercraft to accommodate a plurality of people or objects, designed for a plurality of uses. The watercraft may incorporate an adaptable deck using modular rails, or modular aluminum extrusion. Modular aluminum extrusion in the context of the present invention refers to a structural framing system composed of extruded aluminum, and may include T-slot channels along one or more sides. These slots may allow for easy attachment of accessories, components or connectors at any point along the length of the rail. In this invention, modular aluminum extrusion may be used throughout the frame to provide adaptable, reconfigurable attachment points for various accessories and structural elements, including a pattern of sleeves to accept inserts into the adaptable deck.

The adaptable watercraft-deck assembly may be adaptable in that the sleeves may be incorporated in any pattern and in any quantity into or alongside one or more beams which comprise the watercraft. The watercraft may comprise a modular deck which may accept multipurpose attachments. The sleeves of the watercraft may accept inserts to the watercraft. The rails, modular rails, or modular aluminum extrusion, may provide tiedown and attachment points along the rails for securing cargo and attachment points for one or more multipurpose accessories.

The watercraft may comprise a grouping of sleeve members which align with four or more sleeve members of a trailer, such that the watercraft and trailer share the same grouping of sleeve members, making camping and comfort accessories interchangeable between the boat and trailer.

The watercraft may comprise a grouping of sleeve members to accept inserts for a variety of outdoor, camping, and recreational uses, including but not limited to a tent, one or more propulsion methods, a mast, oarlocks, or accessories to support solar panels. The watercraft may be built catamaran-style and include two parallel hulls symmetrical, spaced-apart and connected together by a deck structure, bridging structure, or crossbeam. The underside of each hull may contain a piece of modular aluminum extrusion that runs along the length of a keel line, referred to as keel MAE.

The watercraft may incorporate beams on one or more hulls to comprise a bow, a stern, a hull, a keel MAE, a left gunnel, a right gunnel, any component of a center tub, and a beam between hulls which is connected at one or more points to one or more hulls. The watercraft beams may be composed of any combination of rails, beams, I-beams, and modular aluminum extrusion.

The rails, modular rails, or modular aluminum extrusion (MAE), may be incorporated into a plurality of components of the watercraft, may be square-shaped and have four functional sides that run the length of the rails. The rails may be used in the assembly of the watercraft such that any number of sides of the rails are exposed and may be used as attachment points for a plurality of uses. Aspects of the watercraft which may incorporate rails include but are not limited to a perimeter of the center tub, a left gunnel, a right gunnel, a keel or keel line, a bow, a stern, and one or more beams connecting hulls of the watercraft. In some preferred embodiments of the watercraft, the rails are comprised of modular aluminum extrusion.

### BRIEF SUMMARY OF THE FIGURES

FIG. 1 is a top left partial perspective view of an embodiment of the present invention;

FIG. 2 is a top left partial perspective view of the watercraft of FIG. 1 illustrating an embodiment of the present invention;

FIG. 3 is a top partial view of the watercraft of FIG. 1, illustrating an embodiment of the present invention;

FIG. 4 is a back side view of the watercraft depicted in FIG. 1, illustrating an embodiment of the present invention;

FIG. 5 is a top left perspective view of the watercraft of FIG. 1, illustrating an embodiment of the present invention; the plastic/composite hull, the left gunnel, and the right gunnel have been removed;

FIG. 6 is a left side perspective view of the watercraft of FIG. 1, illustrating an embodiment of the present invention; the shaded panel depicts the location of a central cross-sectional plane with a portion of the watercraft being removed by the cross-sectional plane;

FIG. 7 is a top left perspective view of the watercraft of FIG. 1, illustrating an embodiment of the present invention;

FIG. 8 is a top right perspective view of a central tub of a watercraft, illustrating a portion of an embodiment of the present invention;

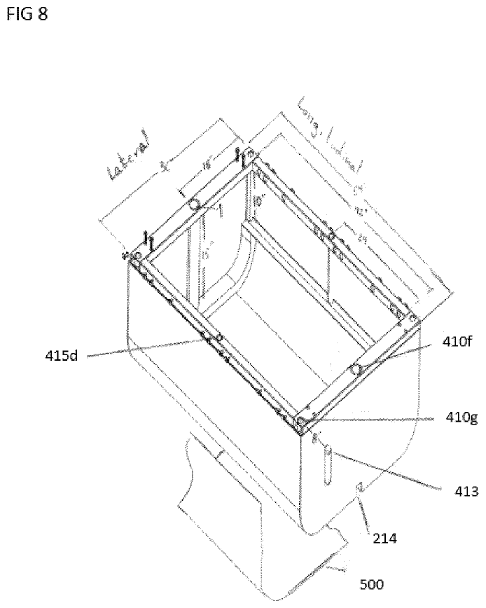

FIG. 9 is a top view of the watercraft of FIG. 1, illustrating an embodiment of the present invention; and,

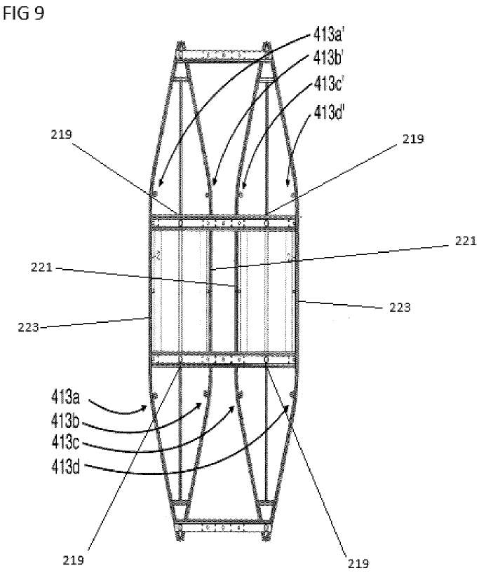

FIG. 10 is a left perspective view of a watercraft with housing poles inserted into a pattern of sleeves, illustrating an embodiment of the present invention.

### DETAILED DESCRIPTION

It will be readily understood that the components of the present invention, as generally described with reference to the drawings herein, could be implemented in a wide variety of different configurations. Thus, the following more detailed description of the embodiments of the system and method of the present invention, is not intended to limit the scope of the invention, but is merely representative of various embodiments of the invention. Unless explicitly described otherwise, using language similar to “at least one A, B, or C” should be interpreted as at least one A, at least one B, at least one C, or any combinations thereof.

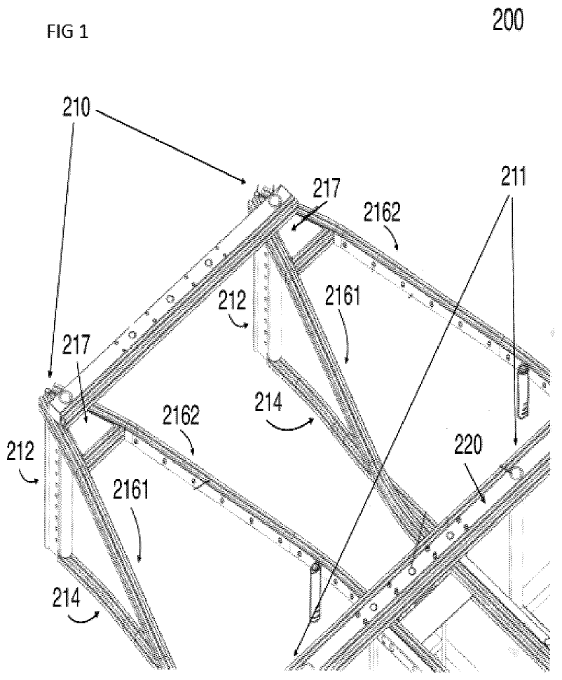

Referring to FIG. 1, a portion of some embodiments of a watercraft system are disclosed. The watercraft system may be a watercraft configured to receive one or more detachably coupleable devices. In some embodiments, the watercraft system may be a watercraft detachably coupled to one or more devices. These detachably coupleable devices may be, but are not limited to, masts, oar locks, hammocks, tents, and shades. A watercraft 200 may be comprised of one or more hulls 210. The one or more hulls may be joined to any number of other hulls at one or more connecting points. A hull 210 may be comprised of a center tub 211, fastened on the center tub's underside to at least one keel MAE 214 which may extend past the center tub on both sides.

In some embodiments, the center tub 211 may be rectangular with a long longitudinal side from bow to stern, and a shorter lateral side across the beam, and a depth of the deadline of the boat. A keel MAE 214 may be fastened in a perpendicular manner to a vertical bow/stern beam 212 on both ends of the keel MAE 214. The top of a center tub 211 may be fastened on one or more sides to a gunnel 216. In some embodiments, a center tub 211 is fastened on one side to the center of a left gunnel 2161, and fasted on the opposite side to the center of a right gunnel 2162, both gunnels extending past the length of the center tub 211 on both sides. One end of a left gunnel 2161 may touch one end of a right gunnel 2162 and be fastened to an end of a vertical bow/stern beam 212 which is perpendicularly fastened to a keel MAE 214. In some embodiments, the ends of two gunnels 216 may be fastened to a triangular keystone 217.

Hull material 215 may cover the features of a hull 210 and form the flooring of a hull 210. In some embodiments, a single piece of flat or rolled plastic or composite hull material 500 is pre-drilled and cut to fit a necessary shape of a watercraft frame. The hull material may be made more pliable with heat. The pliable hull may then be draped over a watercraft frame. In some embodiments, a vertical bow/stern beam 212 may have pre-drilled holes along the web of the beam, and the plastic/composite hull 500 may be sealed to the web using fasteners or a marine grade rope through the web's pre-drilled holes. This may create a watertight hull.

Gunnel washers may be incorporated to provide a larger surface area and structural support at an edge of a hull between a center tub 211 and a keystone 217. In some preferred embodiments, four gunnel washers provide a larger surface area and structural support at a top edge of a plastic/composite hull 500 between a center tub 211 and a keystone 217. One or more sides of a hull 210 may be fastened to one or more other hulls 210 by a horizontal bow/stern beam 220. In some embodiments, a hull 210 may also be architecturally structured, but without a center tub. In some embodiments, a hull may comprise a center structure at the center of the boat other than a center tub 211.

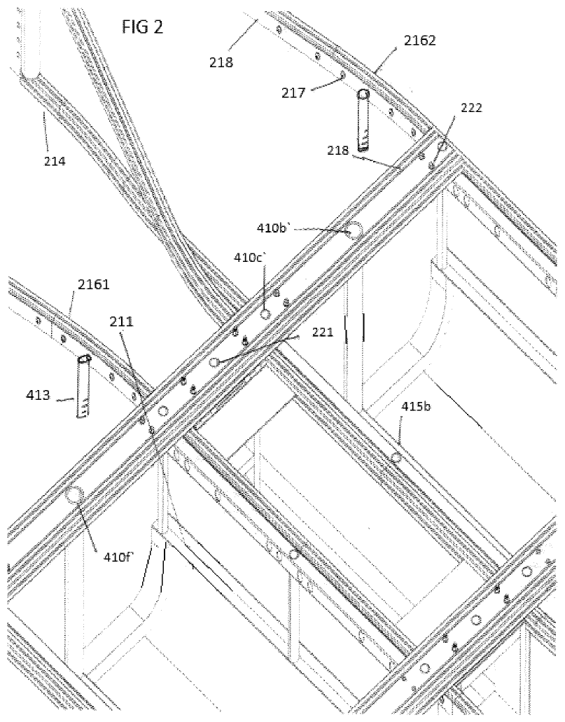

FIG. 2 illustrates a top perspective view of a portion of the watercraft deck, highlighting the modular configuration of sleeve members and their integration into the structural frame. The central main beam 221 may incorporate a linear array of sleeve members (410b, 410c, 410f), each of which may receive vertical or horizontal inserts for mounting accessory sleeves 413 such as tents, housings, or support poles. The surrounding structure may include left 2161 and right gunnels 2162, a center tub 211, crossmember beams, and reinforcing members such as the keystone 217 and gunnel washers 218. A variety of outer sleeves 413 may be placed within sleeve members. The depicted layout may enable a wide variety of accessory placements while maintaining structural integrity and modular interchangeability between the watercraft and compatible trailer platforms.

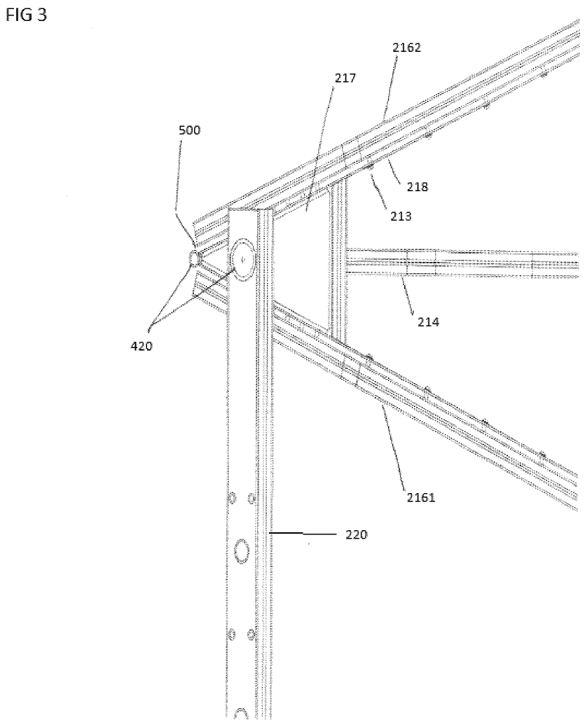

Referring to FIG. 3, a partial front corner view of a watercraft frame, wherein multiple structural components may converge at a modular junction. A vertical horizontal bow/stern beam 212 may be joined to a keystone 217, which may also connect to the forward ends of the left gunnel 2161 and right gunnel 2162. A gunnel washer 218 may be positioned between the gunnel and the keystone to provide increased surface area and structural reinforcement at the connection point. A vertical bow/stern beam 212 may extend downward from the junction and may be used to secure a keel MAE 214, which may run longitudinally and form part of the lower hull structure. In some embodiments, an upright insert sleeve 420 may be mounted at the corner junction. The sleeve 420 may be configured to receive vertical poles or modular accessories such as flagpoles, support posts, or tent frame members. A fastener 500, which may be a bolt, pin, or other coupling device, may be used to secure the intersecting frame elements and maintain structural integrity.

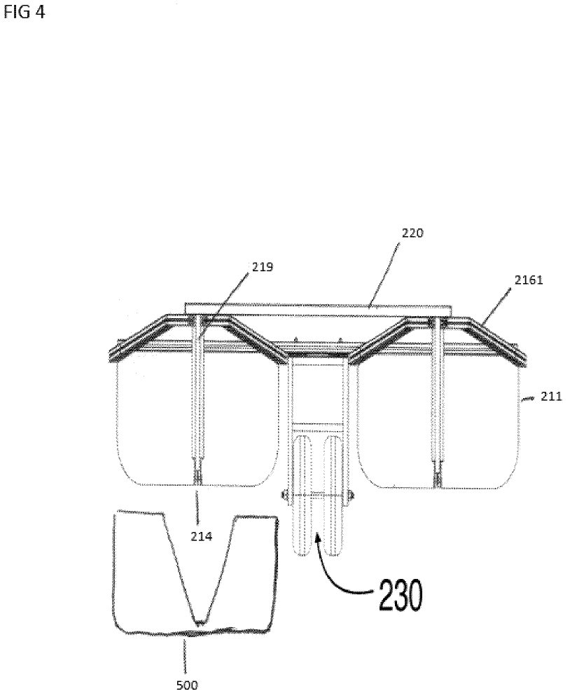

In FIG. 4, a rear elevation view of the watercraft is shown, with particular emphasis on the integration of a landing gear assembly 230 positioned between the two hulls. The landing gear may be mounted to a central portion of the frame structure and may include one or more wheels or rolling components to allow the watercraft to be easily moved over land without lifting. The landing gear may retract, detach, or rotate depending on the embodiment. A center tub 211 may be supported by a keel MAE 214, and a horizontal bow/stern beam 220 may span the width of the deck structure. Left gunnel 2161 and lateral beam 219 components may provide additional support and rigidity to the frame. A fastener may be used to secure portions of the keel or landing gear assembly. This configuration may allow the watercraft to be launched, retrieved, or repositioned with minimal manual effort, enhancing portability and usability for recreational users.

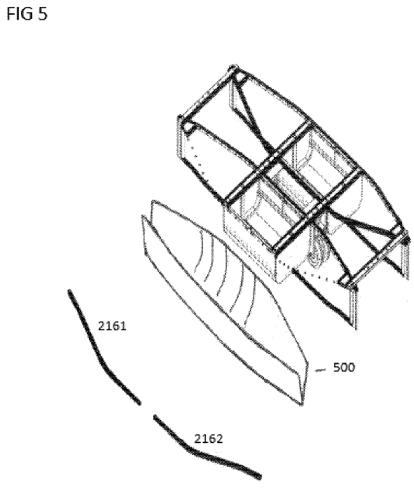

The left gunnel 2161, right gunnel 2162, and plastic composite hull 500 may be shown detached from the main frame to demonstrate how modular elements may be assembled or replaced (FIG. 5). This configuration may allow for convenient repair, customization, or transport. The underlying frame, including keel MAE and center tub structures, may remain intact to support the deck and accessory mounting system.

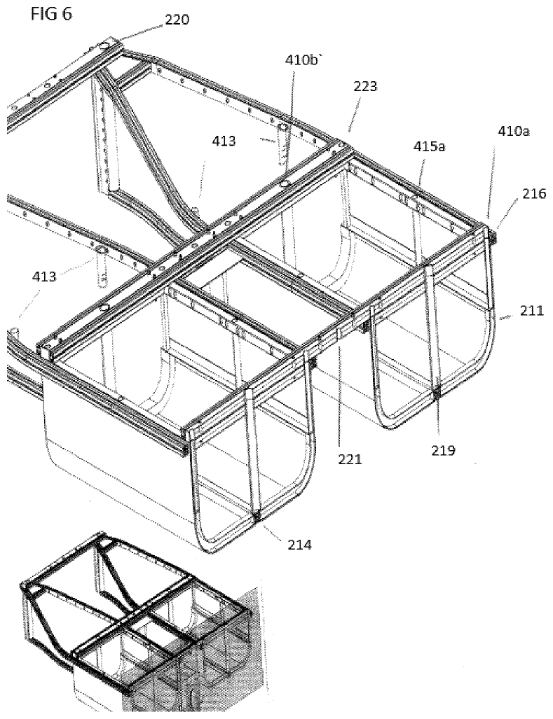

Now referring to FIG. 6, components of a watercraft 200 may incorporate rails comprised of a variety of materials. There may be two parallel hulls 210 connected via a main beam 218 forming a platform supported by modular extrusion components. Each hull may include a center tub 211 which may be supported by keel MAE 214 which may run along the bottom of the hulls and provide longitudinal structure.

The center tub 211 may be framed by gunnels 216 running along the port and starboard sides. These gunnels may incorporate modular aluminum rails designed to accept attachments via sleeve members 410.

Multiple lateral beams 219 may extend transversely between the port and starboard gunnels. Each lateral beam 219 may include a large centered sleeve member 410b (other sleeve locations not shown in FIG. 6), and may also include small lateral sleeves 415a (other sleeve locations not shown in FIG. 6). These sleeve members are designed to receive some or all of the following: tent poles, solar panel brackets, mast supports, and other camping or recreational accessories. The bow/stern beams 220 at either end of the deck may frame the perimeter of the watercraft and connect to the gunnels and keel MAE.

Positioned between the hulls may be one or more interhull sleeves 221 integrated into the transverse beam structure and configured to align with corresponding sleeve members on a compatible trailer. This alignment may allow interchangeable use of accessories between the trailer and watercraft.

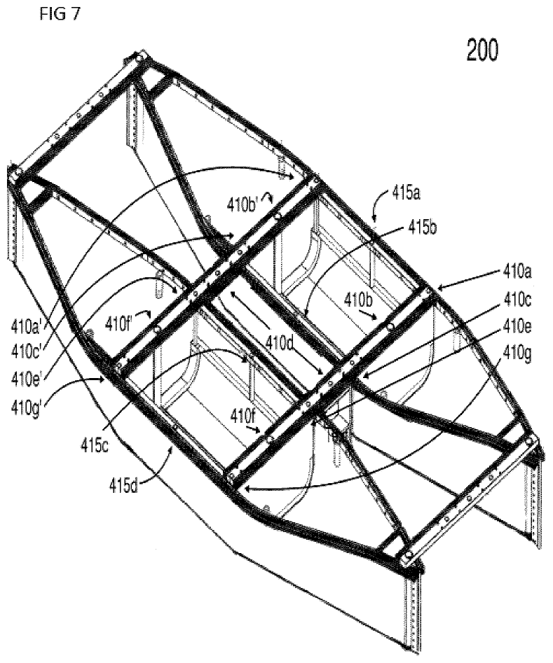

Referring to FIG. 7, the watercraft comprises two longitudinally extending hulls connected by lateral beams, each of which may incorporate sleeves members such as 410a, 410b, 410c, and 410d. These sleeve members may be modular inserts or fixtures designed to receive vertical poles, tent supports, rowing attachments or other recreational components. Each sleeve member may vary in size or function.

A series of perimeter longitudinal beams 223 run along the port and starboard edges of the deck, forming part of the gunnel system. These beams may contain sleeve members 415a, 415b, 415c and 415d. These sleeve members may also be composed of modular aluminum extrusion and may include inserts adaptable to different recreational accessories.

In preferred embodiments, the space under the interhull sleeve between the dual hulls is utilized to house modular components such as rowing stations, removable transoms, gear mounts, and support brackets. Sleeve members 410 within this space are configured to receive vertically or horizontally inserted components, making the watercraft highly adaptable to a variety of use cases including paddling, sailing, or power propulsion.

Sleeve depths may range from approximately 1 inch to 18 inches, depending on their structural placement and intended insert type. Shallow sleeves (which may be between 1 inch to 6 inches deep) may be used for quick-connect accessories like rod holders or lighting posts, while deeper sleeves (which may be between 6 inches to 18 inches deep) provide structural stability for larger components such as tent poles, mast supports, or outboard motor mounts.

The spacing between sleeve members may be designed to accommodate both symmetrical and asymmetrical accessory configurations. In some embodiments, sleeves are spaced at intervals ranging from 3 inches to 12 inches, either linearly along a beam or in grid patterns. Sleeve groupings may be aligned precisely to correspond with identical sleeve patterns on a companion trailer platform, enabling seamless transfer of modular accessories between the watercraft and trailer.

The combination of standardized sleeve spacing and modular aluminum framing allows for a highly customizable and reconfigurable vessel. Users may add, remove, or reposition components without requiring alterations to the base structure, improving the boat's versatility across multiple recreational and functional scenarios.

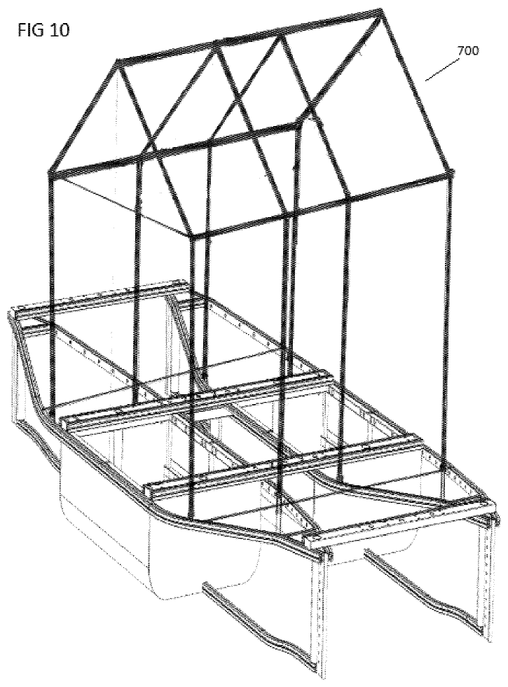

In some embodiments, a housing structure 700 may be created using housing poles that may be inserted directly into sleeve members located along the perimeter of the center tub, along gunnels, or on crossbeams between the hulls (as in FIG. 10). These sleeves provide vertical stability and anchoring for the poles, enabling users to erect shelters such as tents, privacy screens, sunshades, or gear enclosures. In preferred embodiments, the sleeve members may be configured with locking or friction-fit inserts to prevent movement of the poles during use or in inclement weather conditions. The used of the word “insert” as a noun herein may also be referred to as an “attachment.”

It is to be understood that the embodiments of the invention described herein are illustrative and not limiting. The specific configurations, materials, dimensions, arrangements, and functional elements disclosed are provided to facilitate understanding of the invention and to enable implementation of preferred embodiments. However, it will be apparent to those skilled in the art that various changes in form and detail may be made without departing from the spirit and scope of the invention. The principles of modularity, sleeve-based attachment systems, and structural design using modular aluminum extrusion (MAE) may be implemented in a wide range of alternative configurations, including but not limited to pontoon boats, single-hull vessels, floating platforms, amphibious craft, and land-based modular frames. Likewise, the type, location, number, and spacing of sleeve members may be varied to accommodate different use cases or structural needs. All features disclosed in this specification, including the drawings and claims, and/or all of the steps in any method or process disclosed, may be combined in any combination, except combinations where at least some of such features and/or steps are mutually exclusive. Each feature disclosed may be replaced by alternative features serving the same, equivalent, or similar purpose, unless expressly stated otherwise.

What is claimed is:

1. A watercraft comprising:
two hulls having a bow and a stern with opposed sidewalls extending between the bow and the stern;
a frame of two hulls comprising:
a keel modular aluminum extrusion;
a left and right gunnel;
a center tub;
a keystone;
a vertical stern beam;
a hull selected from the group consisting of a plastic hull and a composite hull;
a beam extending between a gunnel and a keel modular aluminum extrusion; wherein the frame comprises a plurality of modular sleeve members receiving at least one insert.

2. The watercraft of claim 1 wherein the watercraft is in the catamaran style, comprising at least two hulls adjoined by one or more beams.

3. The watercraft of claim 2 wherein one or more of the adjoining beams incorporates one or more sleeve members.

4. The watercraft of claim 2 wherein a landing gear comprising at least one wheel is connected to the main beam between the hulls of the watercraft.

5. The watercraft of claim 2 wherein a landing gear comprising at least one wheel is connected to a bow/stern beam.

6. The watercraft of claim 1 wherein the sleeve members are adjoined to the outside of the frame.

7. The watercraft of claim 1 wherein the sleeve members are incorporated into a center of a portion of the frame.

8. The watercraft of claim 1 wherein the frame is comprises modular aluminum extrusion.

9. The watercraft of claim 1 wherein the sleeve members are patterned to align with sleeve members on a trailer.

10. The watercraft of claim 1 wherein the sleeve members are used to insert multi-purpose attachments.

11. A watercraft comprising:
two hulls having a bow and a stern with opposed sidewalls extending between the bow and the stern;
a frame of one or more hulls comprising:
a keel modular aluminum extrusion;
a left gunnel;
and right gunnel;
a center tub;
a keystone;
a vertical stern beam
a beam extending between one end of one or more gunnels and one end of a keel modular aluminum extrusion; wherein the frame comprises aluminum extrusion.

12. A method comprising
providing a watercraft comprising at least two sleeve members arranged so as to form a spatial pattern;
providing a trailer comprising at least two sleeve members so as to form the spatial pattern;
providing an attachment coupled to an accessory, the attachment comprising at least two flanges, arranged in the spatial pattern, wherein the at least two flanges are configured to simultaneously mate with the at least two sleeve members of a watercraft as well as the at least two sleeve members of the trailer;
mating the attachment to the watercraft;
decoupling the attachment from the watercraft;
mating the attachment to the trailer; and,
decoupling the attachment from the trailer.

13. The method of claim 12, wherein the at least two sleeve members of the water craft are at least four sleeve members, wherein the at least two members of the trailer are at least four sleeve members.
